(19) United States
(12) Patent Application Publication
(10) Pub. No.: US 2005/0122232 A1
(43) Pub. Date: Jun. 9, 2005

(54) Method for data exchange between a field apparatus and a cellular phone

(76) Inventor: Vincent DeGroot, St. Louis (FR)

Correspondence Address: BACON & THOMAS, PLLC, 625 SLATERS LANE, FOURTH FLOOR, ALEXANDRIA, VA, 22314, US

(21) Appl. No.: 10/496,832

(22) PCT Filed: Nov. 20, 2002
(86) PCT No.: PCT/EP02/12979

(30) Foreign Application Priority Data
Nov. 27, 2001 (DE) 101 57 764.8

(51) Int. Cl. G08B 29/00

(52) U.S. Cl. 340/870.2; 340/870.1

(57) ABSTRACT

In a method for data exchange between a field device F and a radio telephone FT, the control system L functions as a WAP/WML server and the radio telephone FT as a WAP-client. In this way, information can be presented in the display D of a radio telephone FT.

The invention relates to a method for data exchange between a field device and a radio telephone.

In the technology of process control, field devices are applied in numerous ways for registering and influencing process parameters. Examples of field devices are temperature measurers, which register the temperature of a process medium, flow meters, which register the flow rate of a process medium in a pipeline section, or fill level measurers, which determine the fill level of a liquid or bulk goods in a container. In general, the field devices are connected over a field bus with a control system.

Besides pure measurement transmission, field devices also permit the transmission of various information stored in the field device, such as e.g. parameters (null point, range of measurement values, etc.), measurement curves, and diagnosis information. The parameters can be set by the control system or by an operating device (handheld), this being referred to as configuring and parametering. In this connection, a graphical support for the parameter input is both reasonable and helpful for preventing erroneous input. With every new installation or in the case of device exchange, the field device must normally be newly configured, respectively parametered. Frequently, an accessing of the information of field devices is desired from greater distances. One possibility is to connect the field device through the control device with the intranet, or Internet, as the case may be. Data transmission then occurs over the intranet, or Internet, to a connected computer unit. Thus, for example, the current measurement of the field device can be queried by the computer unit by way of the HTML-page http:/195.123.123.123/measurement.html.

Disadvantageous in this is that the HTML-pages can only be observed on the screen of a computer unit equipped with an appropriate browser. In particular, HTML-pages cannot be observed on the displays of radio telephones due to their limited resolution.

An object of the invention is, therefore, to provide a method for data exchange between a field device and a radio telephone, which permits a simple presentation of field device information.

This object is solved by a method for data exchange between a field device and a radio telephone, wherein the field device is connected through the control unit with the Internet, characterized in that the control system serves as a WAP/WML server, on which the radio telephone accesses as a WAP-client via the Internet.

An essential idea of the invention is that, for presenting the information of a field device, the control system serves as a WAP/WML server, on which the radio telephone has access as a WAP-client. In this way, information can be presented easily on the display of the radio telephone.

Advantageous further developments are given in the dependent claims.

The invention will now be explained in greater detail on the basis of the drawings, which show as follows:

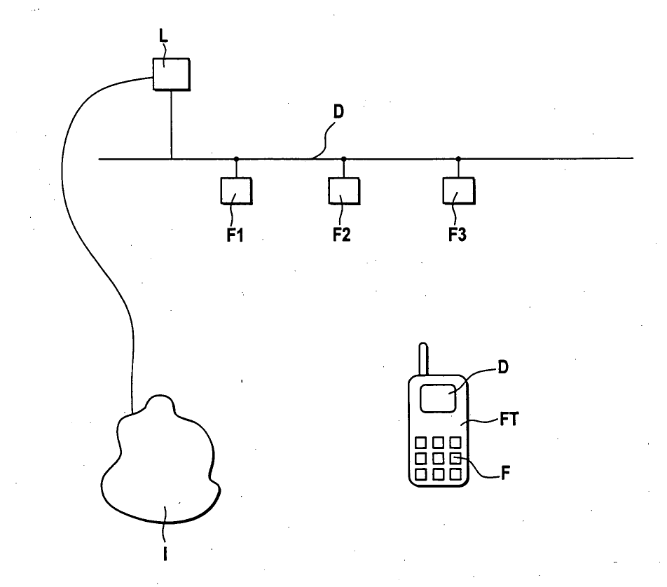

FIG. 1: Field device connected with a control device via the Internet with a radio telephone.

FIG. 1 is a block diagram of an automation setup. A control system L is connected by way of a data bus D with a plurality of field devices F1, F2, F3, etc. The field devices F1-F3 can be e.g. pressure meters, temperature measurers, fill level measurers, flow meters, etc. The control system communicates over the data bus D with the individual field devices, e.g. F1. In this way, data can be transmitted between the field device F1 and the control system L. Data communication on the data bus D occurs on the basis of appropriate international standards, such as e.g. Profibus, CAN or FF. Parametering, respectively configuring, of the field devices can occur from the control system L or from an operating device S. Suitable operating devices are: a portable PC, which is connected directly to the field device or to the data bus; the control system itself; or handheld operating devices enabling a data exchange with the field device.

The control system is connected with the Internet I and functions as a WAP/WML server. Additionally shown in FIG. 1 is a conventional radio telephone FT with keypad T and display D.

The method of the invention will now be explained in greater detail. The user dials the control system with his/her radio telephone FT and requests information from a specific field device, e.g. F1. The control system readies the desired information in the form of a WML-page. This information is simply presented on the display D of the radio telephone FT, which serves as a WAP-client. In this way, a wide variety of information concerning a field device F1 can be transmitted in simple manner to a radio telephone FT and displayed there. Besides the presentation of measurement curves, the graphical support of parametering, respectively configuring, of field devices also makes sense. Since the data is transmitted over public networks, an unauthorized access must be prevented. For this reason, the data exchange occurs with encryption.

1-4. (canceled)

5. A method for data exchange between a field device F and a radio telephone FT, wherein the field device is connected through a control system with the Internet, comprising the step of:
using the control system L functions as a WAP/WML server, which the radio telephone FT accesses as a WAP-client.

6. The method as claimed in claim 5, wherein:
measurement curves are transmitted to the radio telephone FT.

7. The method as claimed in claim 5, wherein:
parametering, respectively configuring, information is transmitted to the radio telephone FT.

8. The method as claimed in claim 5, wherein:
the data exchange occurs with encryption.
